(19) United States
(12) Patent Application Publication
(10) Pub. No.: US 2013/0183153 A1
(43) Pub. Date: Jul. 18, 2013

(54) SYSTEM FOR DETECTING AND CONTROLLING LOADS IN A WIND TURBINE SYSTEM

(71) Applicants: Pekka Tapani Sipilä, Munich (DE); Bharat Sampathkumaran Bagepalli, Niskayuna, NY (US); Sascha Schieke, Greer, SC (US); Nilesh Tralshawala, Rexford, NY (US); Aditi Yogin Koppikar, Bangalore (IN)

(72) Inventors: Pekka Tapani Sipilä, Munich (DE); Bharat Sampathkumaran Bagepalli, Niskayuna, NY (US); Sascha Schieke, Greer, SC (US); Nilesh Tralshawala, Rexford, NY (US); Aditi Yogin Koppikar, Bangalore (IN)

(73) Assignee: GENERAL ELECTRIC COMPANY, SCHENECTADY, NY (US)

(21) Appl. No.: 13/351,269

(22) Filed: Jan. 17, 2012

(51) Int. Cl. F03D 7/00

(52) U.S. Cl. 416/43

(57) ABSTRACT

A wind turbine system comprising a rotatable hub, wind turbine blades attached to the hub, a rotatable shaft mechanically coupled to the hub, a non-shaft-contacting sensor assembly comprising sensors for detecting signals representative of loads induced in the rotatable shaft and a processor for analyzing the signals representative of the loads induced in the rotatable shaft and providing control signals to in response to the induced loads.

### BACKGROUND

The invention generally relates to wind turbine systems, and, more particularly, to systems and methods for detecting and controlling loads in wind turbine systems.

Renewable forms of energy, such as wind power, have become increasingly desirable sources for meeting electrical power requirements. Wind power typically is harvested through the use of a wind turbine that includes a hub having multiple wind turbine blades mechanically coupled to a rotatable shaft. The rotatable shaft is connected to a drive train that includes a gearbox, a power generator, and a power converter that converts mechanical power to electrical power.

To increase the electrical power from wind turbine systems, various approaches have been attempted such as increasing the size of the wind turbine blades and increasing the speed of the rotatable shaft. However, such modifications also increase different types of loads that are induced in the wind turbine system during operation such as bending moment and torque. Additionally, in some instances additional loads may be induced from the utility grid. Induced loads in the wind turbine system are dynamic and result in shorter lifespans of wind turbine components such as rotatable shafts, drivetrains, and towers and further may lead to unexpected outages of the wind turbine system.

Various approaches have been employed for monitoring the health of a wind turbine system and forecasting any defects that may arise. Conventional approaches operate by attaching sensors on the rotatable shaft for detecting the defects in the wind turbine system. Such sensors create undesired complexities in the wind turbine structure and may result in a need for more frequent system maintenance if the sensors have a shorter operating life than the normal wind blade maintenance schedule.

Hence, there is a need for an improved system to address the aforementioned issues.

### BRIEF DESCRIPTION

In one embodiment, a wind turbine system comprises: a rotatable hub, wind turbine blades attached to the hub, a rotatable shaft mechanically coupled to the hub, a non-shaft-contacting sensor assembly comprising sensors for detecting signals representative of loads induced in the rotatable shaft, and a processor for analyzing the signals representative of the loads induced in the rotatable shaft and providing control signals to in response to the induced loads.

In another embodiment, a wind turbine system comprises: a rotatable hub, wind turbine blades attached to the hub, a rotatable shaft mechanically coupled to the hub, a non-shaft-contacting sensor assembly comprising AC susceptometers for detecting signals representative of loads induced in the rotatable shaft, and a processor for analyzing the signals representative of the loads induced in the rotatable shaft and providing control signals to in response to the induced loads.

In yet another embodiment, a wind turbine system comprises: a rotatable hub, wind turbine blades attached to the hub, a rotatable shaft mechanically coupled to the hub, a non-shaft-contacting laser sensor assembly for detecting signals representative of loads induced in the rotatable shaft, and a processor for analyzing the signals representative of the loads induced in the rotatable shaft and providing control signals to in response to the induced loads.

### DRAWINGS

These and other features, aspects, and advantages of the present invention will become better understood when the following detailed description is read with reference to the accompanying drawings in which like characters represent like parts throughout the drawings, wherein:

FIG. 1 is a schematic representation of a wind turbine system in accordance with an embodiment of the invention.

FIG. 2 is a schematic representation of a rotatable shaft including a non-shaft-contacting sensor assembly disposed on a shaft bearing assembly in a wind turbine system in accordance with an embodiment of the invention.

FIG. 3 is a schematic representation of a cross-sectional view of a rotatable shaft including a non-shaft-contacting sensor assembly comprising magnetic field sensors disposed on a shaft bearing assembly in a wind turbine system in accordance with an embodiment of the invention.

FIG. 4 is a schematic representation of a cross-sectional view of a rotatable shaft including a non-shaft-contacting sensor assembly comprising AC susceptometers disposed on a shaft bearing assembly in a wind turbine system in accordance with an embodiment of the invention.

FIG. 5 is a schematic representation of a cross-sectional view of a rotatable shaft including a non-shaft-contacting sensor assembly comprising electromagnetic acoustic transducers disposed on a shaft bearing assembly in a wind turbine system in accordance with an embodiment of the invention.

FIG. 6 is a schematic representation of a cross sectional view of a rotatable shaft including a non-shaft-contacting sensor assembly disposed on a fixture disposed around a circumference of the rotatable shaft in accordance with an embodiment of the invention.

FIG. 7 is a schematic representation of a cross sectional view 42 of a rotatable shaft 22 including the non-shaft-contacting sensor assembly 24 comprising a laser sensor assembly 52 disposed on a fixture 50 disposed around the circumference 30 of the rotatable shaft 22 in accordance with an embodiment of the invention.

### DETAILED DESCRIPTION

Embodiments of the present invention include a wind turbine system comprising a non-shaft-contacting sensor assembly. The non-shaft-contacting sensor assembly includes sensors for detecting modifications in a magnetic field based on loads induced in the rotatable shaft due to wind. The wind turbine system also includes a processor that analyzes the modifications in the magnetic field and provides control signals in response to the induced loads for adjusting the wind turbine system.

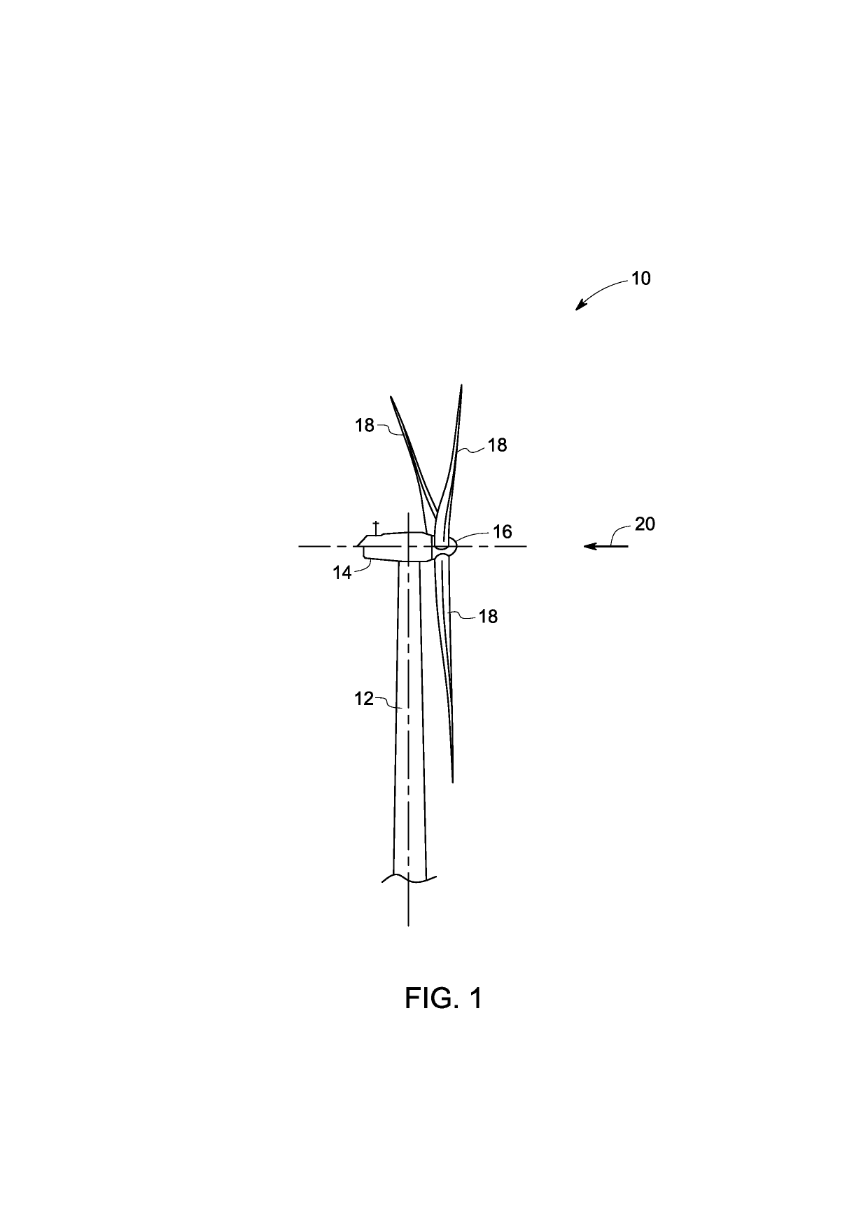

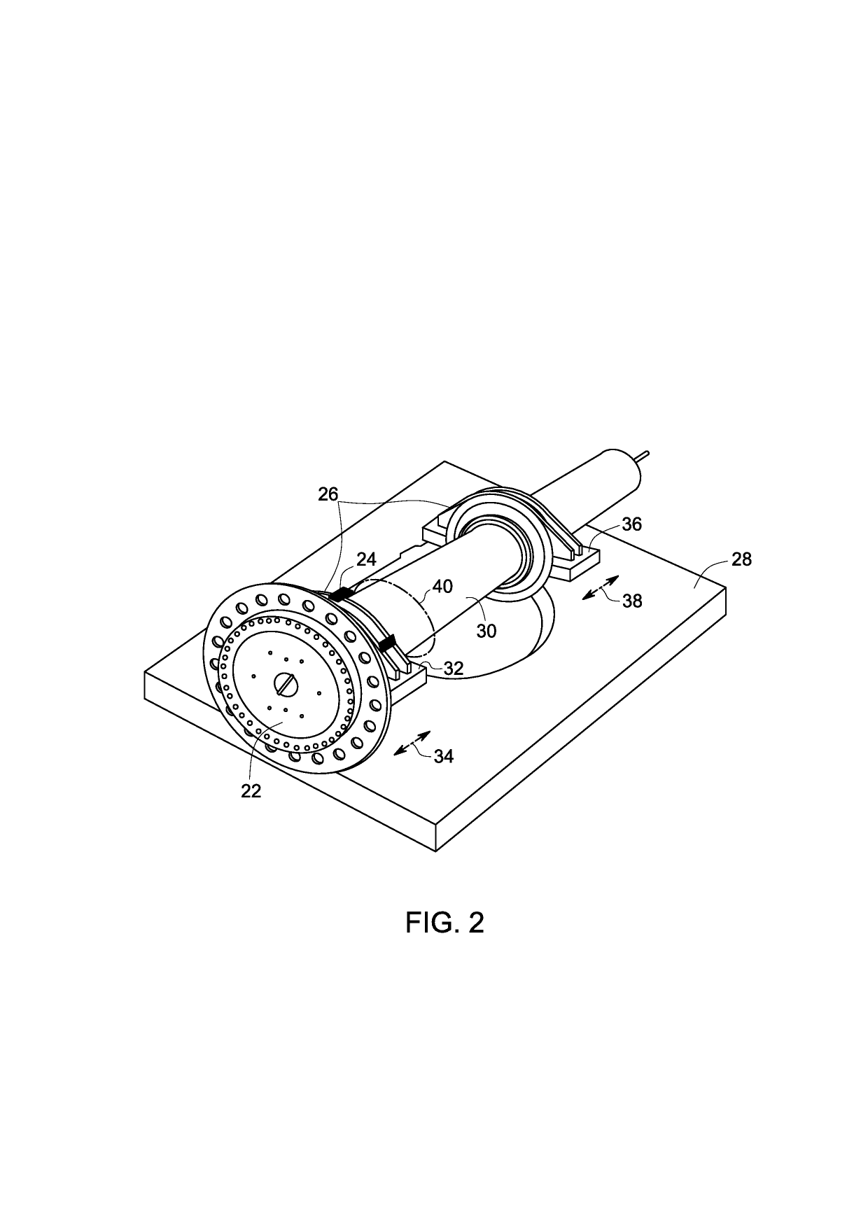

FIG. 1 is a schematic representation of a wind turbine system 10 in accordance with an embodiment of the invention. The wind turbine system 10 includes a tower 12 that supports a nacelle 14 at a desired height from the ground. The nacelle 14 is attached to a hub 16 that includes one or more rotor blades 18 attached thereto. Wind flowing in a direction 20 rotates the one or more blades 18 that further rotate a rotatable shaft (FIG. 2) attached to the hub 16. The wind induces various loads in the rotatable shaft during rotation of the shaft. The rotatable shaft is coupled to a gearbox (not shown) and a power generator (not shown) provided in the nacelle 14 that converts rotations of the rotatable shaft to electrical power that is fed to a power grid (not shown).

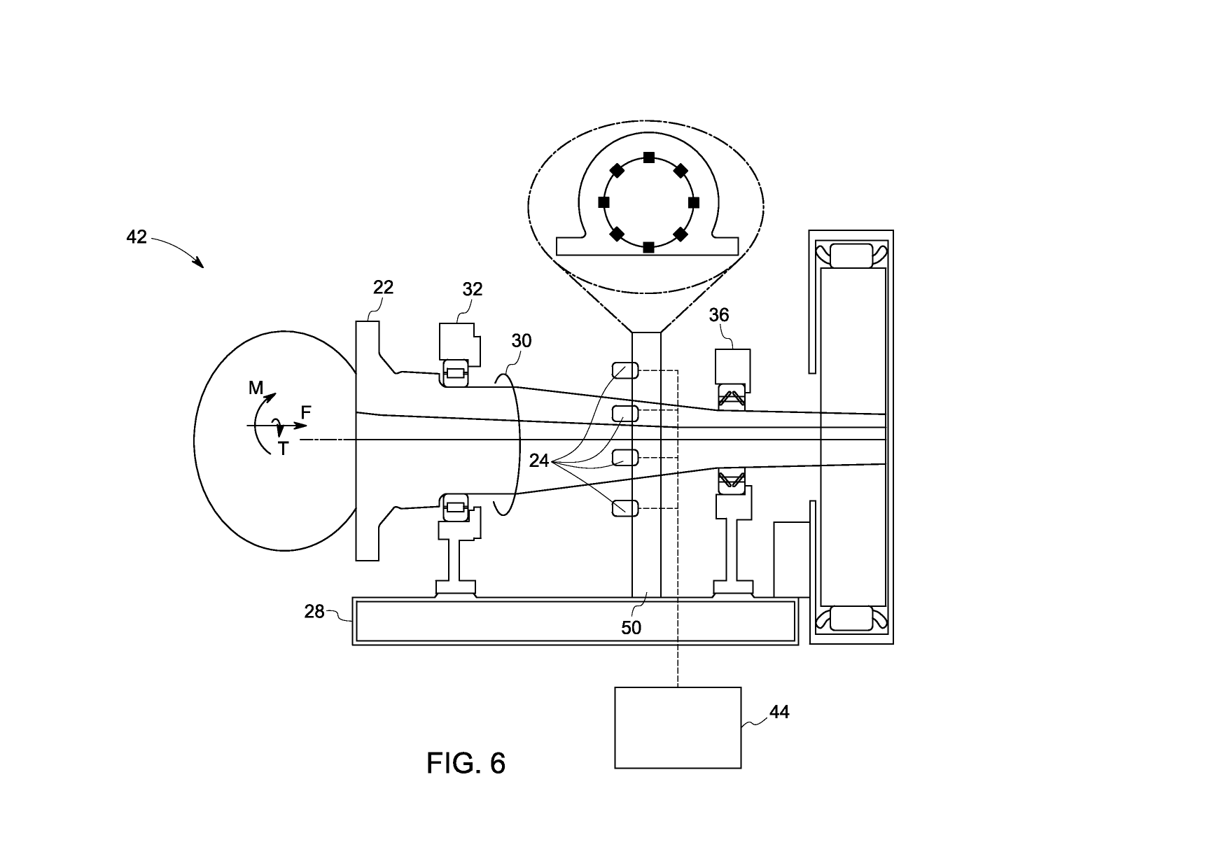

FIG. 2 is a schematic representation of a rotatable shaft 22 including a non-shaft-contacting sensor assembly 24 disposed on a shaft bearing assembly 26 in a wind turbine system (FIG. 1) in accordance with an embodiment of the invention. Non-shaft-contacting sensor assembly 24 is situated in proximity to the rotatable shaft but not in contact with the rotatable shaft, and, although shown as being situated on bearing assembly 26 for purposes of example in FIG. 1, may alternatively be situated on a fixture as shown in FIG. 6 or on other stationary structure within the wind turbine system. The rotatable shaft 22 is disposed on a bed plate 28 provided in the nacelle (FIG. 1) that provides horizontal support to the rotatable shaft 22 in the wind turbine system. In a specific embodiment, the rotatable shaft 22 comprises magneto-restrictive materials. The shaft bearing assembly 26 is attached around a circumference 30 of the rotatable shaft 22 that facilitates the rotatable shaft 22 in rotation during operation. The shaft bearing assembly 26 includes a plurality of bearings that are attached around the circumference 30 of the rotatable shaft at different positions on the rotatable shaft 22. Specifically, the shaft bearing assembly 26 includes a front bearing 32 attached around a front end 34 of the rotatable shaft 22 and a rear bearing 36 attached around the rear end 38 of the rotatable shaft 22. The non-shaft-contacting sensor assembly 24 is disposed on the shaft bearing assembly 26 such that the sensor assembly 24 is not in physical contact with the rotatable shaft 22. In one embodiment, the non-shaft-contacting sensor assembly 24 includes symmetrically spaced sensors 25 disposed on the shaft bearing assembly 26 around the circumference 30 of the rotatable shaft 22. In a specific embodiment, the non-shaft-contacting sensor assembly 24 includes four symmetrically spaced sensors 25 disposed on the shaft bearing assembly 26. In a more specific embodiment, the non-shaft-contacting sensor assembly 24 is disposed either on the front bearing 32 or the rear bearing 36.

If desired, a portion 40 of the rotatable shaft 22 where the induced loads are most likely to occur may be identified. Specifically, the portion may be identified based on actual use or from a prediction based modeling as required. The non-shaft-contacting sensor assembly 24 may then be disposed on the shaft bearing assembly 26 based on a location of the portion 40 on the rotatable shaft 22. For example, if the location of the portion 40 is at the front end 34 of the rotatable shaft 22, the non-shaft-contacting sensor assembly 24 is disposed on the front bearing 32 of the shaft bearing assembly 26. Similarly, the non-shaft-contacting sensor assembly 24 can be disposed on the rear bearing 36. In another embodiment, the non-shaft-contacting sensor assembly 24 may be disposed on a fixture (FIG. 6) disposed around the circumference 30 of the rotatable shaft 22 at any location along the length of the rotatable shaft 22.

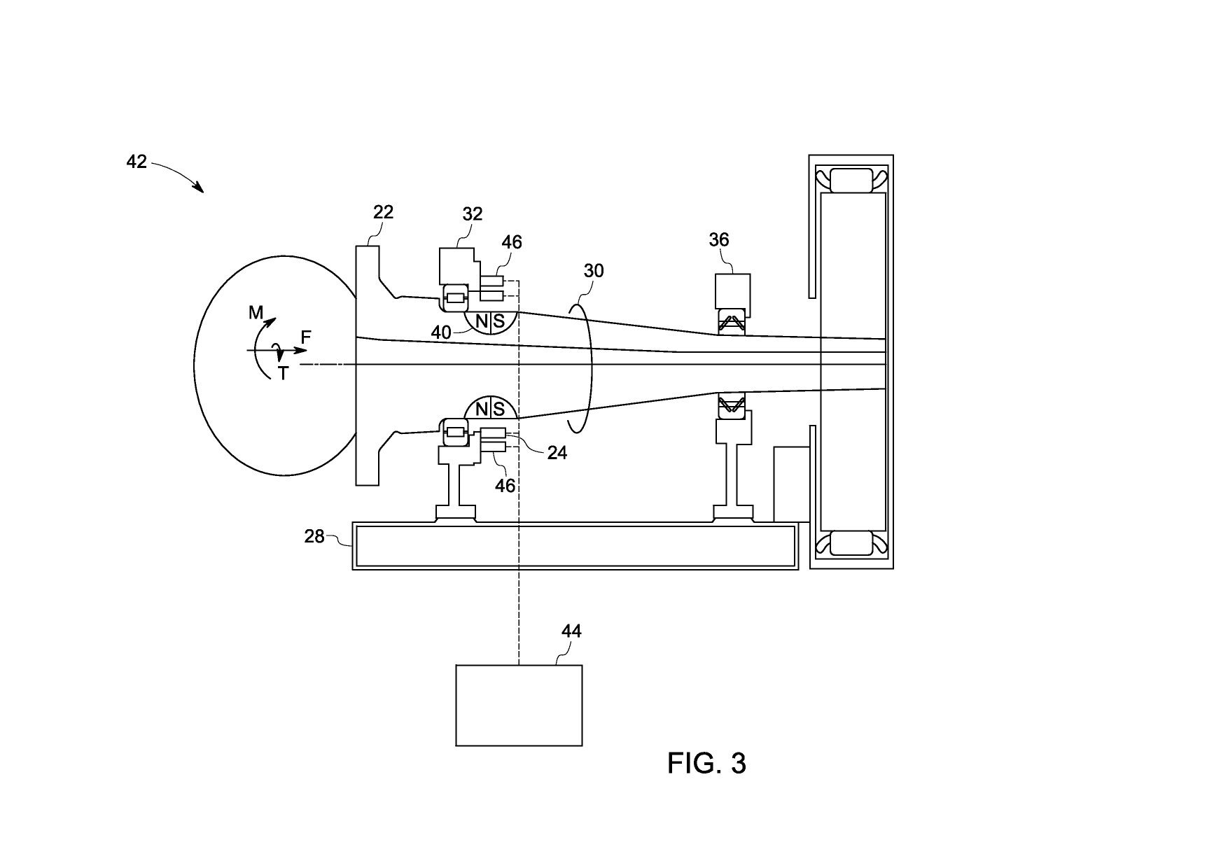

The loads induced in the rotatable shaft 22 generate representative signals that may be detected by the non-shaft-contacting sensor assembly 24 disposed on the shaft bearing assembly 26. The sensors 25 detect the signals and transmit the detected signals to a processor (FIG. 3) that analyzes the signals to identify the kind of load. In one embodiment, the processor additionally sends control signals in response to the induced loads to adjust the wind turbine system (FIG. 1) for controlling the loads. In an exemplary embodiment, the loads may include two-dimensional bending moment, torque, thrust and radial vibrations. In one embodiment, the control signals include blade pitch angle control signals, yaw angle control signals, power conversion control signals, or a combination thereof.

FIG. 3 is a schematic representation of a cross-sectional view 42 of a rotatable shaft 22 including the non-shaft-contacting sensor assembly 24 comprising magnetic field sensors disposed on the shaft bearing assembly 26 in the wind turbine system (FIG. 1) in accordance with an embodiment of the invention. The rotatable shaft 22 or the portion 40 thereof may be magnetized using various known techniques. In one embodiment, the rotatable shaft 22 may be magnetized during manufacturing of the rotatable shaft 22 or prior to installing the non-shaft-contacting sensor assembly 24 in an existing wind turbine system. The non-shaft-contacting sensor assembly 24 comprising magnetic field sensors are disposed the shaft bearing assembly 26 around the circumference 30 of the magnetized portion 40 of the rotatable shaft 22. In another embodiment, the magnetic field sensors may be disposed on the fixture (FIG. 6) around the circumference 30 of the magnetized portion of the rotatable shaft 22.

The magnetic field sensors generate a magnetic field in the magnetized portion of the rotatable shaft 22 including magnetic field lines that are modified when a load is induced in the rotatable shaft 22 during operation. The modifications in the magnetic field lines are detected by the sensors and are transmitted to the processor 44 for analyzing the modifications and identifying the load induced in the rotatable shaft 22. In an exemplary embodiment, the magnetic field sensors may include pick-up coils, magneto-resistance sensors, magneto-impedance sensors, flux-gate sensors, Hall-effect based sensors, micro-electromechanical sensors, and/or magneto-optical sensors. The processor 44 may further send control signals to various components of the wind turbine system to control the blade pitch angle, yaw angle, power conversion output, or a combination thereof. In an exemplary embodiment, the non-shaft-contacting sensor assembly 24 includes auxiliary sensors 46 that detect radial vibrations in the wind turbine system and transmit detected signals to the processor 44 for controlling the radial vibrations. The auxiliary sensors may also be used to detect changes in the background magnetic field during rotation of the turbine or any electromagnetic interference to filter the detected signals. The auxiliary signals may additionally or alternatively include temperature sensors that detect the temperatures of the rotatable shaft 22 and the sensors 25.

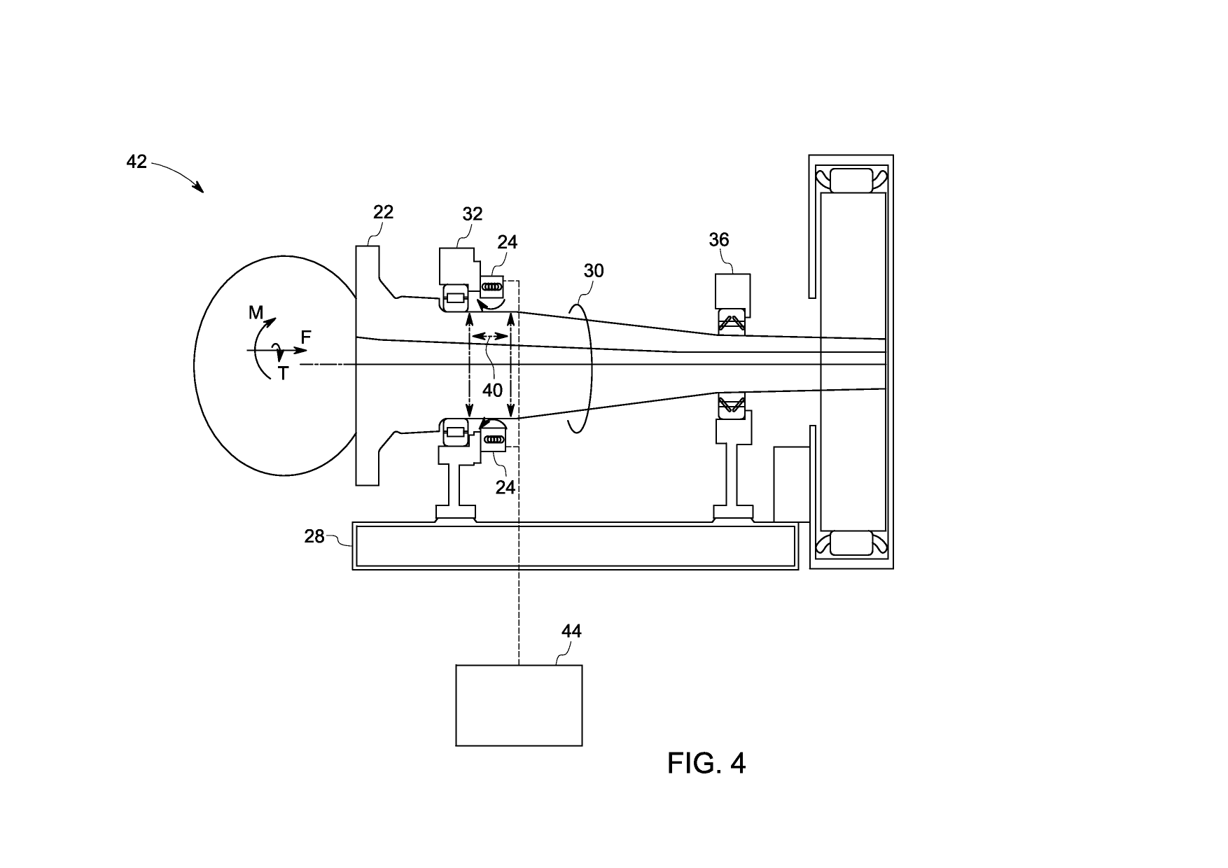

FIG. 4 is a schematic representation of an alternative embodiment depicting a cross-sectional view 42 of the rotatable shaft 22 including the non-shaft-contacting sensor assembly 24 comprising AC susceptometers or fluxmeters disposed on the shaft bearing assembly 26 in the wind turbine system in accordance with an embodiment of the invention. In this particular embodiment, the non-shaft-contacting sensor assembly 24 includes AC susceptometers or fluxmeters to detect the modifications in the rotatable shaft. The AC susceptometers or fluxmeters include inductive coils that are operated with an external power source (not shown). The inductive coils generate an alternating current field that is transmitted through the portion 40 of the rotatable shaft 22 surrounded by the AC susceptometers or fluxmeters.

During operation, loads induced in the rotatable shaft 22 may modify susceptibility of the rotatable shaft 22 based on the characteristics of the magneto-restrictive materials. The modifications in the susceptibility are detected by the AC susceptometers or fluxmeters. In one embodiment, the power consumption of the inductive coils indicates the distance between the inductive coils, and modifications in the power consumption are analyzed to control the vibrations in the wind turbine system. In another embodiment, different frequencies are used for each of the AC susceptometer or fluxmeter to avoid cross talk and distinguish between different AC susceptometers provided in the non-shaft-contacting sensor assembly 24.

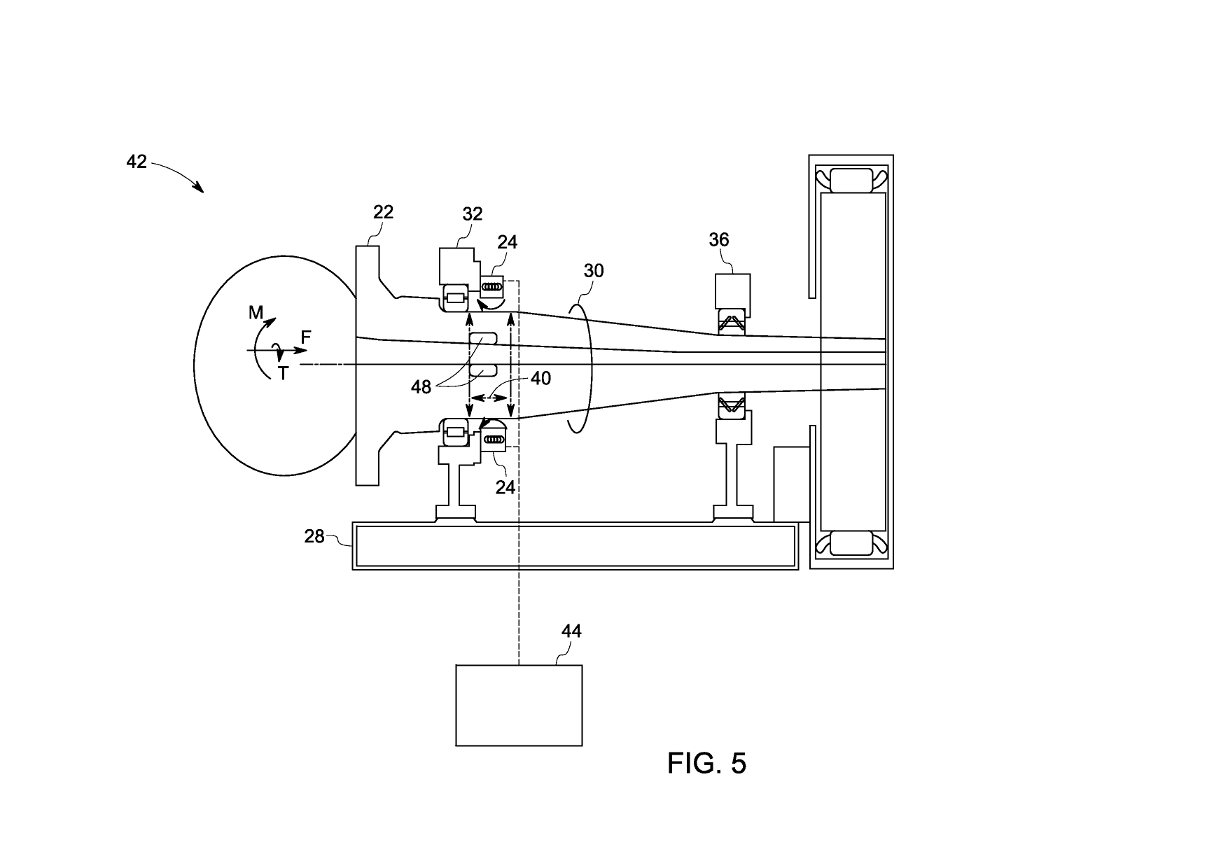

FIG. 5 is a schematic representation of yet another embodiment of the rotatable shaft 22 including the non-shaft-contacting sensor assembly 24 comprising electromagnetic acoustic transducers disposed on the shaft bearing assembly 26 in the wind turbine system in accordance with an embodiment of the invention. In a particular embodiment, the non-shaft-contacting sensor assembly 24 comprises electromagnetic acoustic transducers. The electromagnetic acoustic transducers generate acoustic waves that are transmitted through the portion 40 of the rotatable shaft 22 surrounded by the electromagnetic acoustic transducers. The electromagnetic acoustic transducers apply a magnetic field in the identified portion 40 that induces acoustic waves based on the Lorentz phenomenon. The induced loads modify the acoustic wave propagation constant of the magneto-restrictive material of the rotatable shaft 22. The modification in the propagation constant changes the propagation of the acoustic waves transmitted through the rotatable shaft 22. The change in the propagation of the acoustic waves may be detected by magnetometers 48 also situated at the shaft bearing assembly 26 that receive the acoustic waves transmitted through the rotatable shaft 22. The magnetometers 48 receive pulses induced by the acoustic waves while propagating through the rotatable shaft 22 and transfer the pulses to the processor 44 that analyzes the pulses receives from the magnetometers 48 and identifies the load. In one embodiment, the power consumption of the electromagnetic acoustic transducers indicates the distance between the electromagnetic acoustic transducers and modifications in the power consumption are analyzed to control the vibrations in the wind turbine system.

FIG. 6 is a schematic representation of a cross sectional view 42 of a rotatable shaft 22 including the non-shaft-contacting sensor assembly 24 disposed on a fixture 50 disposed around the circumference 30 of the rotatable shaft 22 in accordance with an embodiment of the invention. The non-shaft-contacting sensor assembly 24 may be disposed on the fixture 50 provided around the circumference 30 of the rotatable shaft 22. This embodiment may be used to locate the non-shaft-contacting sensor assembly 24 at a location where the shaft bearing assembly 26 is not present and is particularly useful when the induced loads are expected to occur at that other location.

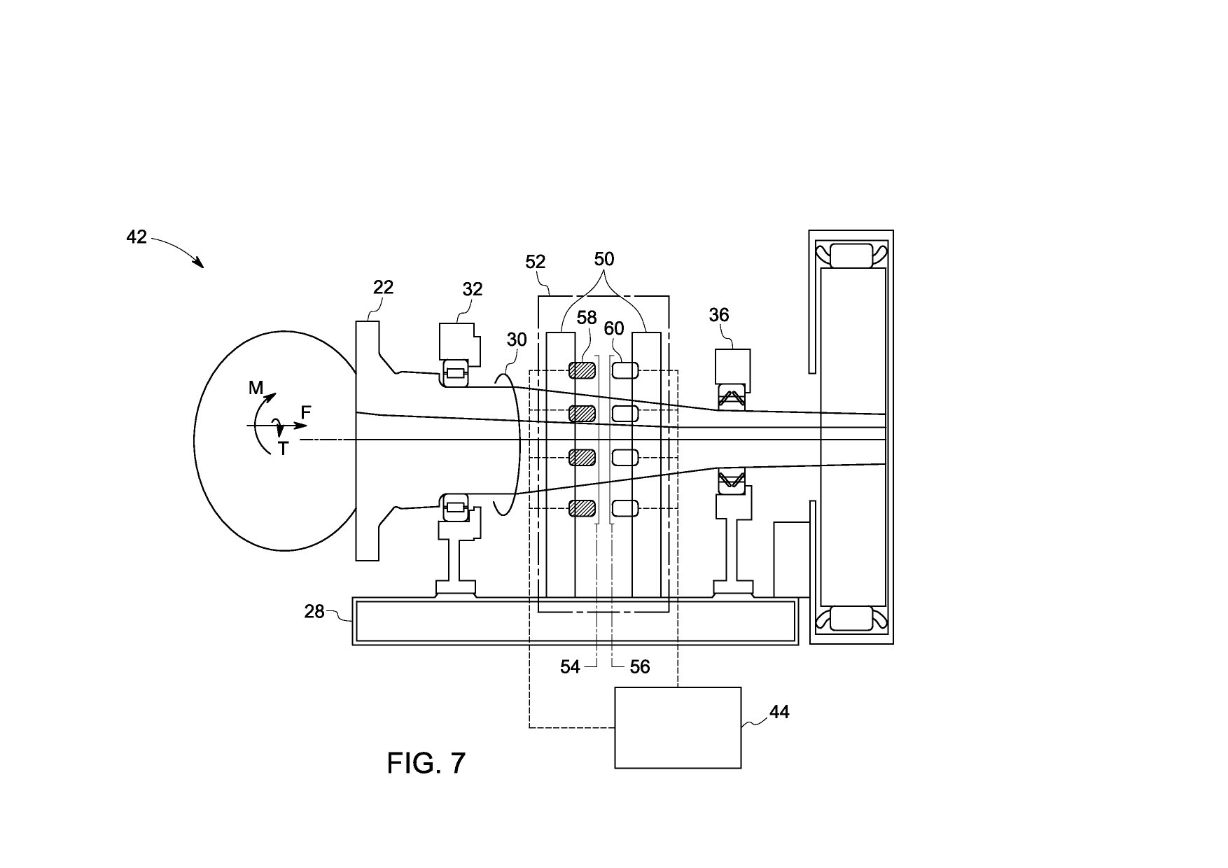

FIG. 7 is a schematic representation of a cross sectional view 42 of a rotatable shaft 22 including a non-shaft-contacting sensor assembly comprising a laser sensor assembly 52 disposed on a fixture 50 disposed around the circumference of the rotatable shaft 22 in accordance with an embodiment of the invention. The non-shaft-contacting sensor assembly 24 includes a laser sensor assembly 52 that detects loads induced in the rotatable shaft 22 during operation. The laser sensor assembly 52 of FIG. 7 includes a transmitter assembly 54 and a receiver assembly 56 disposed on two fixtures 50 provided along the length of the rotatable shaft 22 around the circumference 30 (FIG. 6) of the rotatable shaft 22. In a specific embodiment, the two fixtures 50 can be disposed at any desired location along the length of the rotatable shaft 22 at any desired distance between the transmitter assembly 54 and the receiver assembly 56. The transmitter assembly 54 may include laser ultrasonic transducers 58 that transmit ultrasonic waves along the length of the rotatable shaft 22. In one embodiment, the ultrasonic waves are transmitted at least at a Nyquist frequency. The laser ultrasonic transducers 58 may be disposed around the circumference of the rotatable shaft 22 in a symmetrical manner and therefore, transmit the ultrasonic waves around the circumference of the rotatable shaft 22. The ultrasonic waves are received by the receiver assembly 56 that includes sensors 60 to detect the ultrasonic laser waves reflected from the rotatable shaft 22. In one embodiment, the sensors 60 include complementary metal oxide semiconductor sensors. In another embodiment the ultrasound laser transducers 58 in the transmitter assembly 54 and the sensors 60 in the receiver assembly 56 can be disposed at any desired angle on the fixture 50. In a specific embodiment, the transmitter assembly 54 and the receiver assembly 56 can be disposed on the front bearing 32. In a more specific embodiment, the transmitter assembly 54 and the receiver assembly 56 can be disposed on the rear bearing 36. The sensors 60 detect the ultrasonic waves reflected from the rotatable shaft 22 and transmit the detected ultrasonic waves to the processor 44 that analyzes the detected ultrasonic waves to identify the load induced in the rotatable shaft 22 and may also send control signals to adjust the identified load.

The various embodiments of the wind turbine system described above provide a more efficient and reliable sensor assembly for detecting signals representative of the loads induced in the rotatable shaft. The non-shaft-contacting sensor assembly enables to reduce complexities in the rotatable shaft structure and less maintenance costs.

It is to be understood that a skilled artisan will recognize the interchangeability of various features from different embodiments and that the various features described, as well as other known equivalents for each feature, may be mixed and matched by one of ordinary skill in this art to construct additional systems and techniques in accordance with principles of this disclosure. It is, therefore, to be understood that the appended claims are intended to cover all such modifications and changes as fall within the true spirit of the invention.

While only certain features of the invention have been illustrated and described herein, many modifications and changes will occur to those skilled in the art. It is, therefore, to be understood that the appended claims are intended to cover all such modifications and changes as fall within the true spirit of the invention.

1. A wind turbine system comprising:
a rotatable hub;
wind turbine blades attached to the hub;
a rotatable shaft mechanically coupled to the hub;
a non-shaft-contacting sensor assembly comprising sensors for detecting signals representative of loads induced in the rotatable shaft; and
a processor for analyzing the signals representative of the loads induced in the rotatable shaft and providing control signals in response to the induced loads.

2. The system of claim 1, further comprising a shaft bearing assembly and wherein the non-shaft-contacting sensor assembly is disposed on the shaft bearing assembly.

3. The system of claim 2, wherein the sensors are symmetrically spaced on the shaft bearing assembly around a circumference of the rotatable shaft.

4. The system of claim 1, wherein the sensors comprise four sensors.

5. The system of claim 1, wherein the sensors comprise magnetic field sensors.

6. The system of claim 1, wherein the sensors comprise AC susceptometers or fluxmeters.

7. The system of claim 1, wherein the sensor assembly further comprises electro-magnetic acoustic transducers or laser ultrasound transducers.

8. The system of claim 1, wherein the sensor assembly further comprises auxiliary sensors for detecting vibrations in the wind turbine system, a displacement between the shaft and sensor frame, a temperature, and changes in background magnetic field, or combinations thereof.

9. The system of claim 1, wherein the control signals comprise blade pitch angle control signals, yaw angle control signals, power conversion control signals, or a combination thereof.

10. The system of claim 1, wherein the sensor assembly is disposed on a fixture provided around a circumference of the rotatable shaft.

11. A wind turbine system comprising:
a rotatable hub;
wind turbine blades attached to the hub;
a rotatable shaft mechanically coupled to the hub;
a non-shaft-contacting sensor assembly comprising alternating current susceptometers for detecting signals representative of loads induced in the rotatable shaft; and
a processor for analyzing the signals representative of the loads induced in the rotatable shaft.

12. The system of claim 11, further comprising a shaft bearing assembly, and wherein the non-shaft-contacting sensor assembly is disposed on the shaft bearing assembly.

13. The system of claim 12, wherein the AC susceptometers are symmetrically spaced on the shaft bearing assembly around the circumference of the rotatable shaft.

14. The system of claim 11, wherein at least some of the AC susceptometer operate at different frequencies.

15. The system of claim 11, further comprising auxiliary sensors for detecting vibrations in the wind turbine system, displacement between the shaft and sensor frame, temperature and changes in background magnetic field.

16. The system of claim 11, wherein the sensors are disposed on a fixture provided around the circumference of the rotatable shaft.

17. The system of claim 11, wherein the sensor assembly is situated in a wind turbine system, and wherein the processor is further configured for adjusting the wind turbine system by adjusting a blade pitch angle, a yaw angle, a power converter output, or a combination thereof.

18. A wind turbine system comprising:
a rotatable hub;
wind turbine blades attached to the hub;
a rotatable shaft mechanically coupled to the hub;
a non-shaft-contacting laser sensor assembly for detecting signals representative of loads induced in the rotatable shaft; and
a processor for analyzing the signals representative of the loads induced in the rotatable shaft and providing control signals in response to the induced loads.

19. The system of claim 18, wherein the non-shaft-contacting laser sensor assembly comprises a transmitter assembly and a receiver assembly disposed on fixtures.

20. The system of claim 19, wherein the transmitter assembly comprises ultrasonic laser transducers, and wherein the receiver assembly comprises complementary metal oxide sensors.
